(19) United States
(12) Patent Application Publication
(10) Pub. No.: US 2026/0007908 A1
(43) Pub. Date: Jan. 8, 2026

(54) SYSTEM AND METHOD FOR REMOVABLY ATTACHING PERSONAL PROTECTIVE EQUIPMENT (PPE) TO AN AIR INTAKE DEVICE

(71) Applicants: Mark McBride, Coronado, CA (US); Phillip Salvatori, Salem, OR (US); John Roughneen, Dennis, MA (US)

(72) Inventors: Mark McBride, Coronado, CA (US); Phillip Salvatori, Salem, OR (US); John Roughneen, Dennis, MA (US)

(21) Appl. No.: 19/254,226

(22) Filed: Jun. 30, 2025

Related U.S. Application Data
(60) Provisional application No. 63/667,740, filed on Jul. 4, 2024.

(51) Int. Cl. A62B 9/04; A41D 13/05; A62B 7/10

(52) U.S. Cl. CPC A62B 9/04; A41D 13/0556; A62B 7/10

(57) ABSTRACT

Systems, methods, and other embodiments for removably attaching personal protective equipment (PPE) to an air intake device, including an air intake device having a removable filter, a personnel protective equipment (PPE), wherein the PPE includes an opening located on a portion of the PPE such that the opening is sized and shaped to accommodate one end of the removable filter, a sealing flange operatively connected to the opening, a gasket seal, wherein the gasket seal is configured to be retained within the sealing flange, and a plurality of fasteners located around a periphery of the one end of the removable air filter, wherein the plurality of magnets are configured to interact with the gasket seal and sealing flange to removably attach the PPE to the removable air filter.

### CROSS-REFERENCE TO RELATED APPLICATION

This application claims benefit of U.S. Patent Application 63/667,740, filed on Jul. 4, 2024, the disclosure of which is hereby incorporated by reference in its entirety to provide continuity of disclosure to the extent such a disclosure is not inconsistent with the disclosure herein.

### FIELD OF THE INVENTION

The present invention is generally related to a system and method for removably attaching personal protective equipment (PPE) to an air intake device. The system enables the user to quickly and easily attach PPE such as surgical gowns or togas and/or surgical hoods to an air intake device. The air intake device is used to provide a flow of air within the PPE while the PPE is used during a medical procedure such as a surgical procedure. The system includes a removable sealing system that allows the PPE to be quickly and easily attached to the air intake device and the sealing system provides an air tight seal around the attachment between the PPE and the air intake device. Furthermore, once the medical procedure has been completed, the system is configured to allow the PPE to be quickly and easily removed from the air intake device so that the PPE can be properly disposed.

### BACKGROUND OF THE INVENTION

Prior to the present invention, as set forth in general terms above and more specifically below, it is known that an air intake device may need to be used in conjunction with PPE in order to properly perform a medical procedure such as a surgical procedure. For example, PPE such as surgical gowns or togas, along with surgical hoods, can be used to perform medical procedures. While the medical personnel are wearing the PPE, air needs to be provided to the medical personnel since the PPE is constructed to cover the upper body, shoulders, neck, and head of the medical personnel. In order to provide air to the medical personnel, the medical personnel need to support the air intake device on the head, neck and/or shoulders of the medical personnel. Also, there needs to be an opening in the PPE that allows the air intake device to properly provide fresh air from outside of the PPE to the medical personnel.

In order to provide adequate fresh air for the air intake device, typically, an opening is cut in the PPE and the air intake device is taped or otherwise securely attached to the PPE at the opening in the PPE. While this known system and method for securing the PPE to the air intake device can provide a way to attach the PPE to the air intake device while reducing the likelihood of any unwanted air from entering into the PPE, this known system and method is time consuming and expensive. Furthermore, once the medical procedure has been completed, the air intake device needs to be removed from the PPE. During this removal of the PPE from the air intake device, the air intake device and/or the PPE may become damaged. Clearly, this removal process can be time consuming and expensive.

Furthermore, it is known that installing and sealing the PPE gown over a filter opening on an air intake device with the use of an elastic interface can create ease of use issues for the assistant. For example, in order to get the PPE gown to seal, an elastic membrane (such as a Kraton™) must be stretched over the filter. This can be difficult for the user because the unit can shift the position of the device on the medical personnel such as a surgeon. The elastic membrane may also be installed too far over the filter and would require the PPE gown to be removed and the process started again.

Therefore, it would be desirable to provide a system and method for removably attaching personal protective equipment (PPE) to an air intake device. Furthermore, it would be desired to be able to reduce the time and expense in attaching a PPE to an air intake device and removing the PPE from the air intake device. Finally, it would be desired to provide a system and method for removably attaching personal protective equipment (PPE) to an air intake device that provides an adequate amount of fresh air to the air intake device.

It is a purpose of this invention to fulfill these and other needs in the attaching personal protective equipment (PPE) to an air intake device art in a manner more apparent to the skilled artisan once given the following disclosure.

The preferred system and method for removably attaching personal protective equipment (PPE) to an air intake device, according to various embodiments of the present invention, offers the following advantages: ease of use; the ability to quickly and easily attach the PPE to the air intake device; the ability to quickly and easily remove the PPE from the air intake device; the ability to provide an adequate amount of fresh air to the air intake device; reduced weight; and reduced costs to attaching personal protective equipment (PPE) to an air intake device. In fact, in many of the preferred embodiments, these advantages are optimized to an extent that is considerably higher than heretofore achieved in prior, known systems and methods of attaching personal protective equipment (PPE) to an air intake device.

### BRIEF DESCRIPTION OF THE DRAWINGS

The above-mentioned features and steps of the invention and the manner of attaining them will become apparent, and the invention itself will be best understood by reference to the following description of the embodiments of the invention in conjunction with the accompanying drawings, wherein like characters represent like parts throughout the several views and in which:

FIG. 1 is a schematic, isometric view of a known air intake device having a removable filter, according to one embodiment of the prior art;

FIG. 2 is a schematic illustration of a conventional PPE gown, wherein an opening is formed in the PPE gown for use in attaching the air intake device to the air intake device, constructed according to one embodiment of the prior art;

FIG. 3 is a schematic, isometric view of a system for removably attaching an air intake device to a PPE, constructed according to one embodiment of the present invention;

FIG. 4 is an isometric illustration of the system for removably attaching an air intake device to a PPE, taken at circle A in FIG. 3, constructed according to one embodiment of the present invention;

FIG. 5 is cross-sectional view of the system for removably attaching an air intake device to a PPE, taken along lines 5-5 in FIG. 3 constructed according to one embodiment of the present invention;

FIG. 6 is an exploded, front view of the system for removably attaching an air intake device to a PPE, constructed according to one embodiment of the present invention;

FIG. 7 is an exploded, rear view of the system for removably attaching an air intake device to a PPE, constructed according to one embodiment of the present invention;

FIG. 8 is a front view of the system for removably attaching an air intake device to a PPE with the fasteners such as magnets or snaps attached to the air intake device, constructed according to one embodiment of the present invention;

FIG. 9 is a rear view of the system for removably attaching an air intake device to a PPE with the gasket seal permanently attached to the PPE and the air intake device positioned near the gasket seal, constructed according to one embodiment of the present invention;

FIG. 10 is a front view of the system for removably attaching an air intake device to a PPE with the gasket seal permanently attached to the air intake device, constructed according to one embodiment of the present invention;

FIG. 11 is a front view of the system for removably attaching an air intake device to a PPE with the gasket seal permanently attached to the air intake device and the PPE positioned near the gasket seal, constructed according to one embodiment of the present invention;

FIG. 12 is a front view of the system for removably attaching an air intake device to a PPE with the gasket seal permanently attached to the air intake device and the air filter removed, constructed according to one embodiment of the present invention;

FIG. 13 is another front view of the system for removably attaching an air intake device to a PPE with the gasket seal permanently attached to the PPE and the air filter removed, constructed according to one embodiment of the present invention;

FIG. 14 is a rear view of the system for removably attaching an air intake device to a PPE with the gasket seal permanently attached to the PPE and the air intake device positioned near the gasket seal, constructed according to one embodiment of the present invention;

FIG. 15 is a close-up section view of the system for removably attaching an air intake device to a PPE with the gasket seal permanently attached to the PPE and the air filter removed, taken along circle B in FIG. 16, constructed according to one embodiment of the present invention;

FIG. 16 is a section view of the system for removably attaching an air intake device to a PPE with the gasket seal permanently attached to the PPE and the air filter removed, taken along lines 16-16 in FIG. 12, constructed according to one embodiment of the present invention;

FIG. 17 is an isometric view of a snap-on adapter assembly for use in attaching the air intake device to the PPE, constructed according to one embodiment of the present invention;

FIG. 18 is an isometric, front view of the snap-on adapter assembly being attached to the air intake device, constructed according to one embodiment of the present invention;

FIG. 19 is an isometric, exploded view of the snap-on adapter assembly, constructed according to one embodiment of the present invention;

FIG. 20 is an isometric, rear view of the snap-on adapter assembly prior to being attached to the PPE, constructed according to one embodiment of the present invention;

FIG. 21 is an isometric, front view of the snap-on adapter assembly prior to being attached to the PPE, constructed according to one embodiment of the present invention;

FIG. 22 is an isometric, front view of the snap-on adapter assembly being attached to the PPE, constructed according to one embodiment of the present invention;

FIG. 23 is an isometric, rear view of the snap-on adapter assembly being attached to the PPE, constructed according to one embodiment of the present invention;

FIG. 24 is a close-up section view of the system for removably attaching an air intake device to a PPE utilizing the snap-on adapter assembly taken from circle C in FIG. 22, constructed according to one embodiment of the present invention;

FIG. 25 is an enlarged section view of the system for removably attaching an air intake device to a PPE utilizing the snap-on adapter assembly, taken from FIG. 24, constructed according to one embodiment of the present invention; and

FIG. 26 are schematic illustrations of the various shaped openings that the PPE can have in order to attach to the air intake device, constructed according to one embodiment of the present invention.

### DETAILED DESCRIPTION OF THE PREFERRED EMBODIMENTS OF THE INVENTION

In order to address the shortcomings of the prior, known systems and methods of attaching personal protective equipment (PPE) to an air intake device, it would be desirable to provide a system and method for removably attaching personal protective equipment (PPE) to an air intake device. Furthermore, it would be desired to be able to reduce the time and expense in attaching a PPE to an air intake device and removing the PPE from the air intake device. Finally, it would be desired to provide a system and method for removably attaching personal protective equipment (PPE) to an air intake device that provides an adequate amount of air to the air intake device.

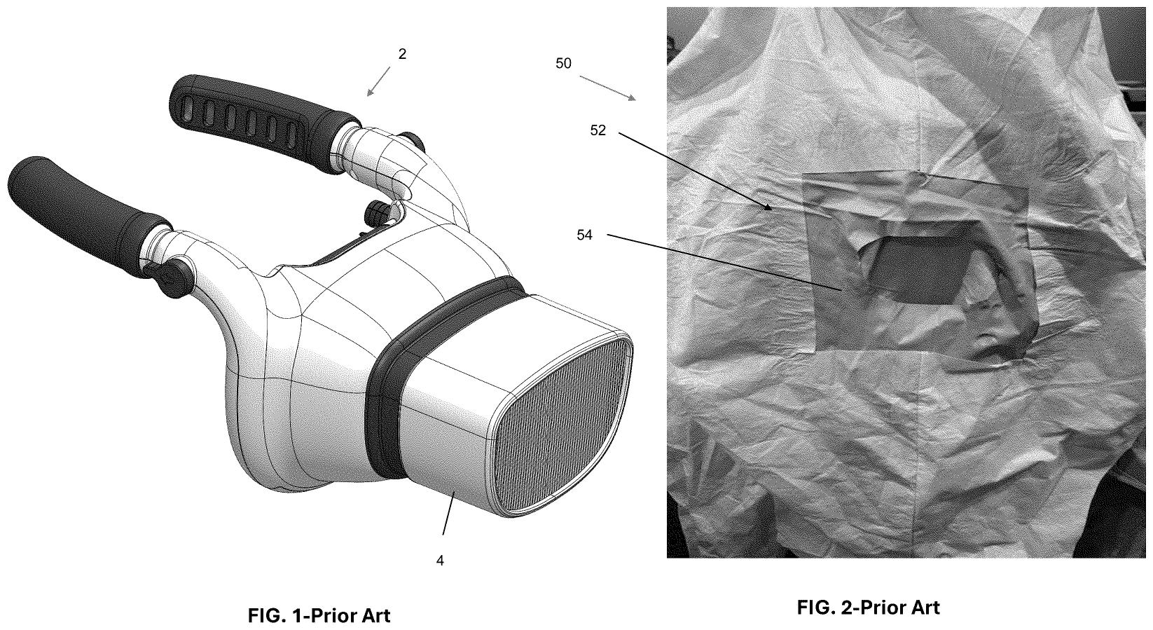

Referring now to FIGS. 1 and 2, there are illustrated a known air intake device 2 having a removable filter 4 and a known personal protective equipment (PPE) 50 having an opening 52 and a seal 54. As previously discussed, the known method to attach the air intake device 2 at removable filter 4 to the opening 52 in the PPE 50 is to use adhesives and/or elastic membrane (not shown). The seal 54 is used to ensure that no other outside air enters into the PPE 50 except through the opening 52. It is to be understood that PPE 50 can be, but is not limited to, a surgical gown, toga, and/or a surgical hood. It is also to be understood that the air intake device 2 can be, but is not limited to, a fan assembly that is worn on the head, neck, and/or shoulders of the medical personnel.

### System for Removably Attaching Personal Protective Equipment (PPE) to an Air Intake Device

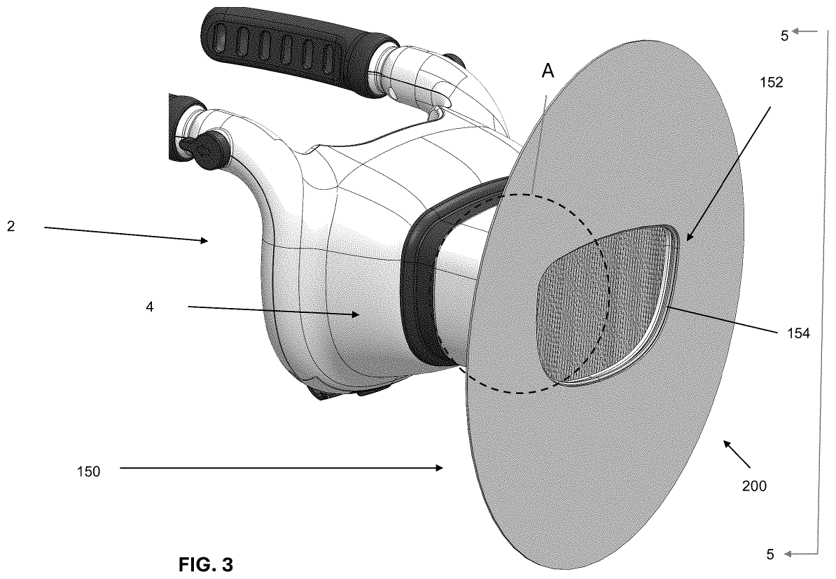

With respect to FIG. 3, there is illustrated a novel system 200 for removably attaching personal protective equipment (PPE) 150 to an air intake device 2 having a removable filter 4. As shown in FIG. 3, PPE 150 also includes an opening 152 and a seal 154. It is to be understood that PPE 150 is similar to PPE 50 in FIGS. 1 and 2, except that PPE 150 includes a unique opening 152 that is sized and shaped to accommodate the shape of the end of the removable filter 4 or air intake device 2.

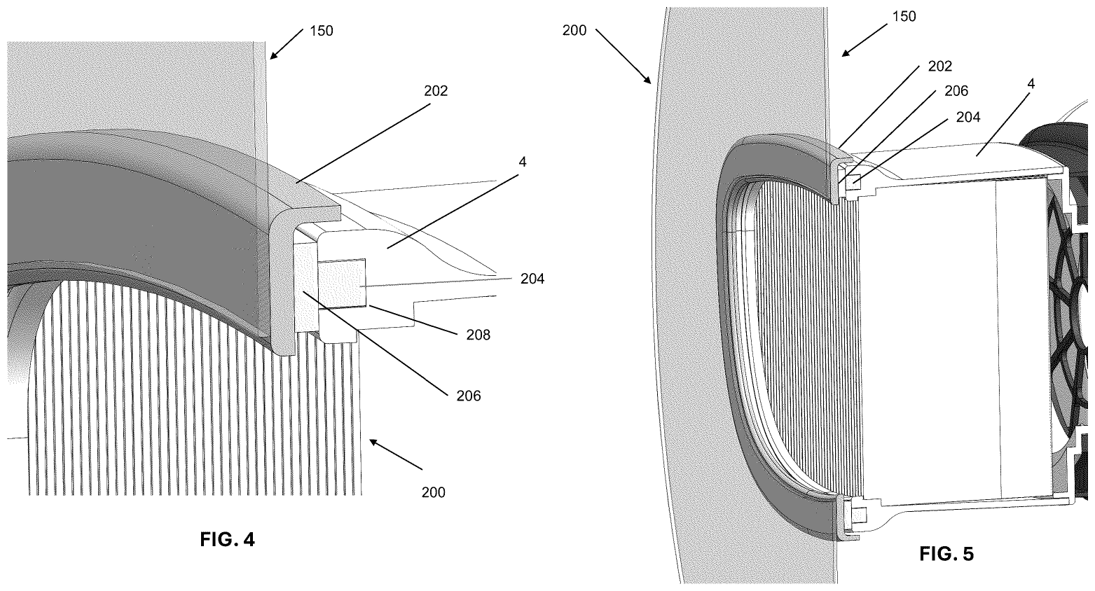

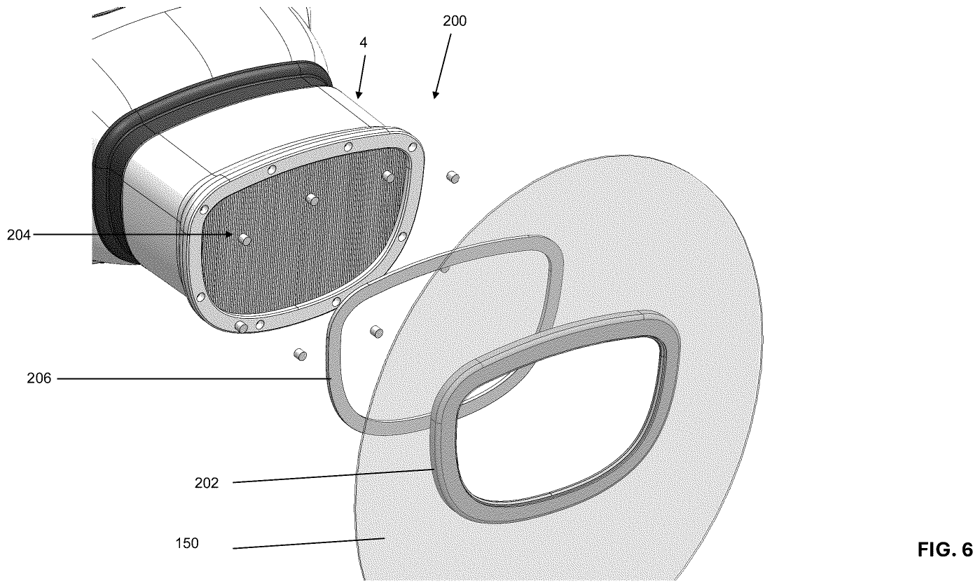

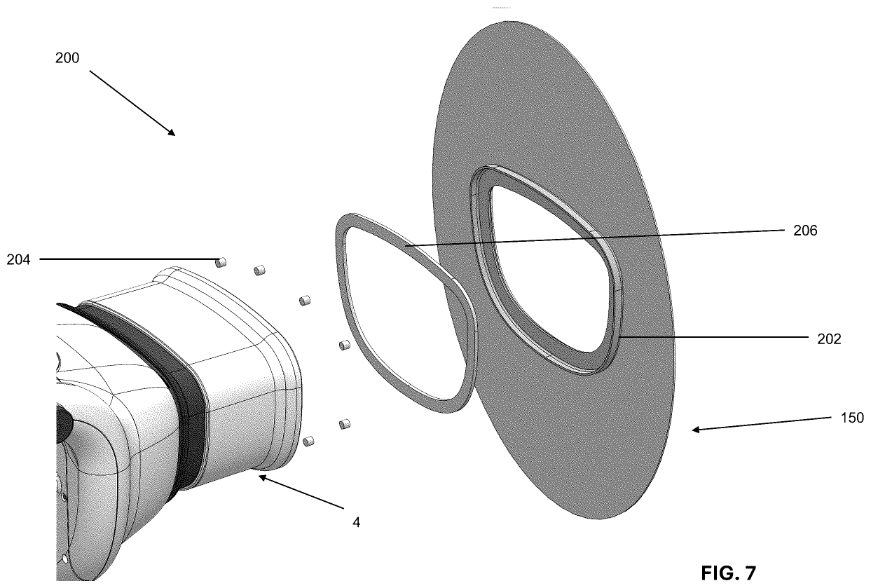

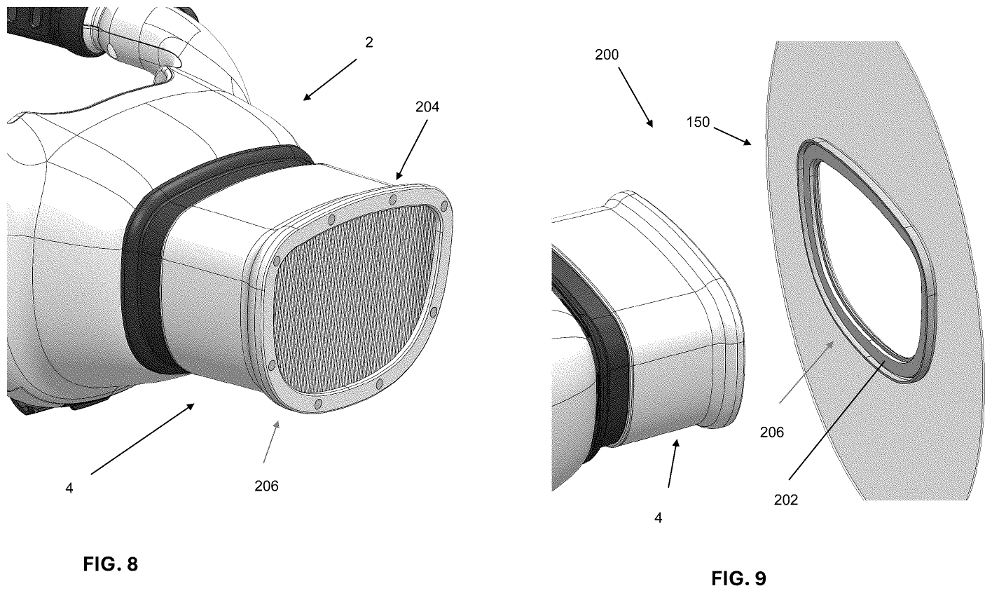

With respect to FIGS. 4-8, there is illustrated a first embodiment of the system 200. As shown in FIGS. 4 and 5, system 200 includes, in part, sealing flange 202, fasteners 204 such as magnets or snaps, and gasket seal 206. Preferably, sealing flange 202 and gasket seal 206 are constructed of any suitable, durable, UV resistant, heat resistant, high strength material. Also, sealing flange 202 and the gasket seal 206, preferably, are constructed of a material that is able to interact with fasteners 204 such as magnets or snaps in order to assist in attaching the gasket seal 206 and the sealing flange 202 to the removable filter 4 or the air intake device 2. Also, gasket seal 206, preferably, is configured so that it creates a compression and friction fit when it is inserted into sealing flange 202 and the fasteners 204 such as magnets or snaps pull on the gasket seal 206 and sealing flange 202. Also, fasteners 204 such as magnets or snaps are located around a periphery of groove 208 that is conventionally formed in the removable filter 4 (FIG. 6). Finally, it is to be understood that snaps or other similar fasteners can be used in place of the magnets as long as the gasket seal 206 also includes similar snaps or other similar fasteners (not shown) that are capable of interacting with the fasteners located around the periphery of the groove 208.

Another unique aspect of the present invention is the use of snaps instead of magnets. In one embodiment, snaps could be constructed of any suitable, durable, UV resistant, rust resistant polymeric material. In this manner, the cost to produce and use the snaps would be significantly lower than using rare-earth magnets such as magnets. Furthermore, once the surgical procedure has been completed and the PPE used during the surgical procedure is to be disposed, it will be more cost effective and easier to dispose of PPE that includes polymeric snaps than magnets that may be made of rare earth materials.

With respect to FIG. 9, there is illustrated a unique aspect of the present invention. In particular, as shown in FIG. 9, the gasket seal 206 can be attached to the sealing flange 202. The sealing flange 202 is attached to the PPE 150. The system 200 can be attached to the air intake device 2 at the removable filter 4 through the use of fasteners 204 such as magnets or snaps. In this manner, when the PPE 150 is finished, being used, the medical personnel can simply remove the PPE 150 from the air intake device 2 at the removable filter 4 and properly dispose of the PPE 150.

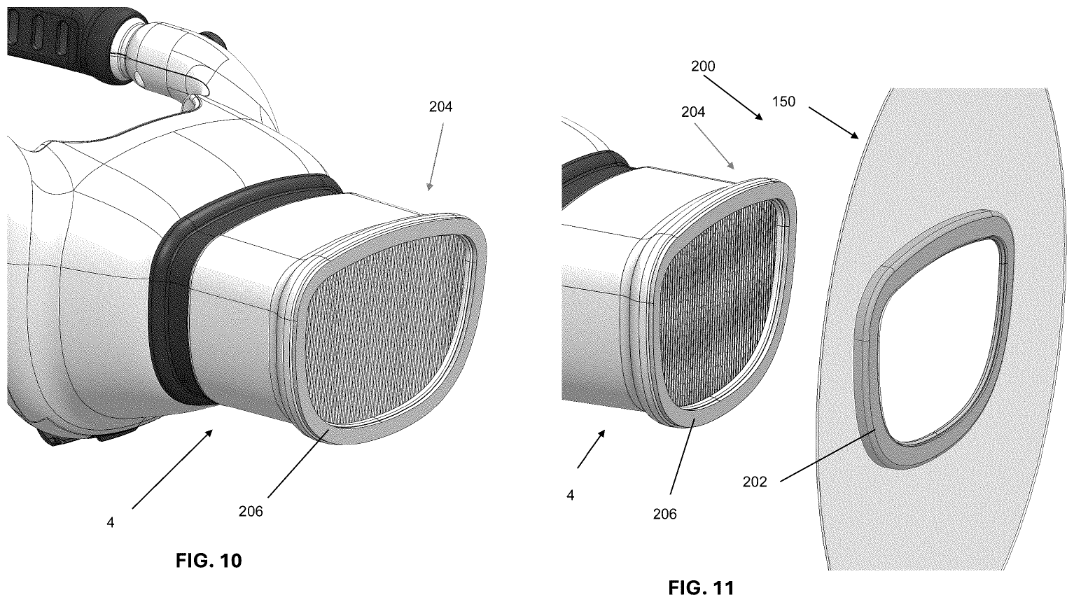

With respect to FIGS. 10 and 11, there is illustrated another unique aspect of the present invention. In particular, as shown in FIGS. 10 and 11, the gasket seal 206 can be attached to the removable filter 4. The sealing flange 202 is attached to the PPE 150. In this manner, when the PPE 150 is finished, being used, the medical personnel can simply remove the PPE 150 from the air intake device 2 at the removable filter 4 and properly dispose of the PPE 150.

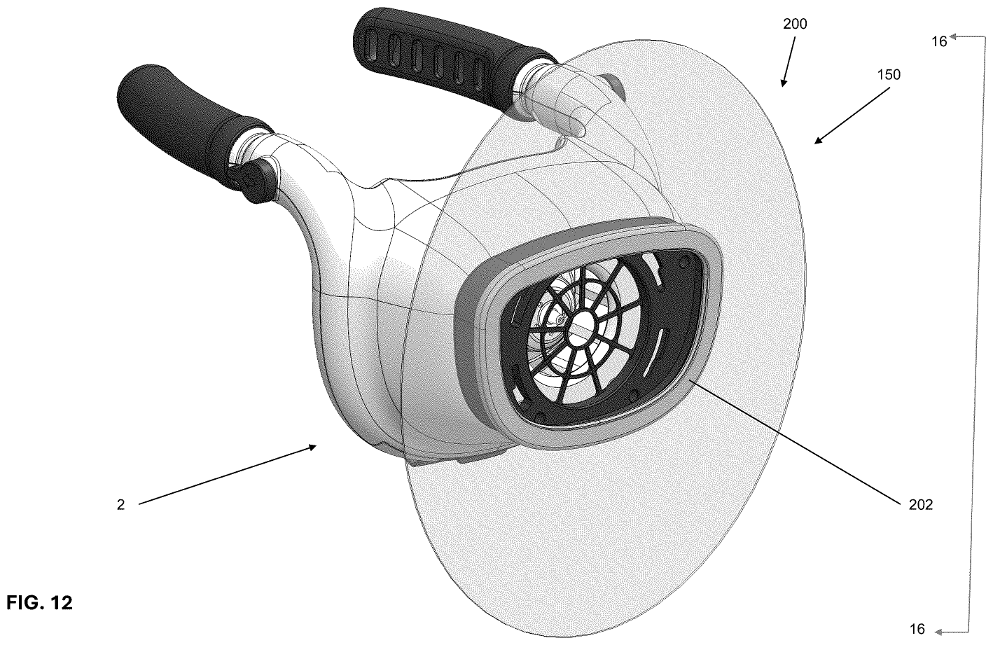

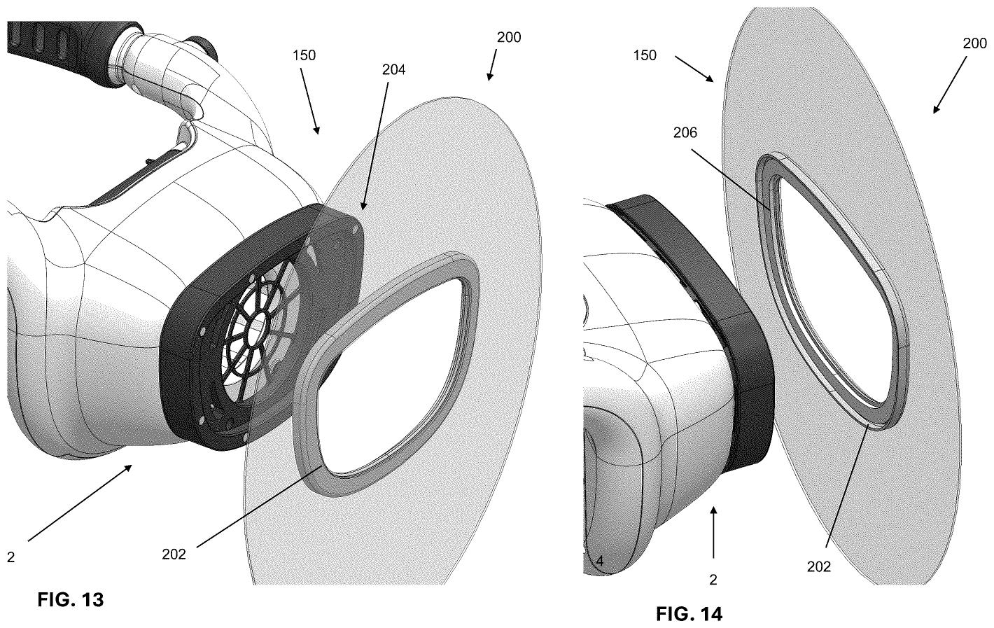

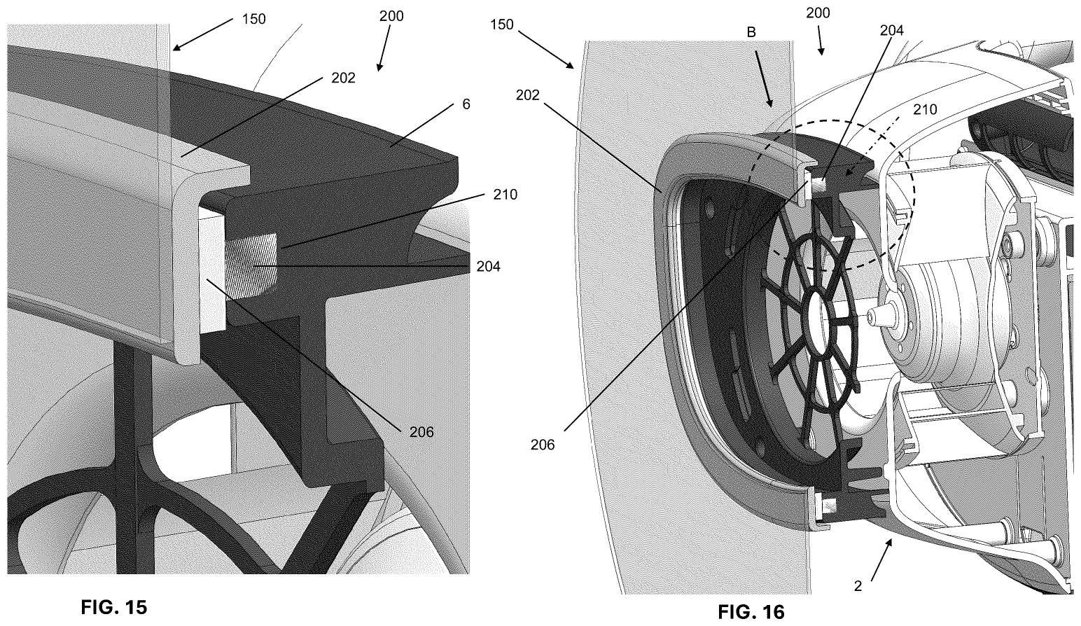

With respect to FIGS. 12-16, there is illustrated still another unique aspect of the present invention. In particular, the removable filter 4 has been removed from the air intake device 2. In this embodiment, the system 200 is connected to the air intake device 2 through the use of a recess 210 (FIGS. 15 and 16) that is conventionally formed in the air intake device 2. As best shown in FIGS. 15 and 16, the fasteners 204 such as magnets or snaps are located around the periphery of the recess 210 that is conventionally formed in the end of the air intake device 2. Also, the PPE 150 is attached to the sealing flange 202 and the gasket seal 206 is attached to the sealing flange 202. In this manner, when the PPE 150 is finished, being used, the medical personnel can simply remove the PPE 150 from the air intake device 2 and properly dispose of the PPE 150.

It is to be understood that the gasket seal 206 can also be attached to the removable filter 4 at the plurality of fasteners 204 such as magnets or snaps or the gasket seal 206 can be attached to sealing flange 202, as discussed above, in this embodiment.

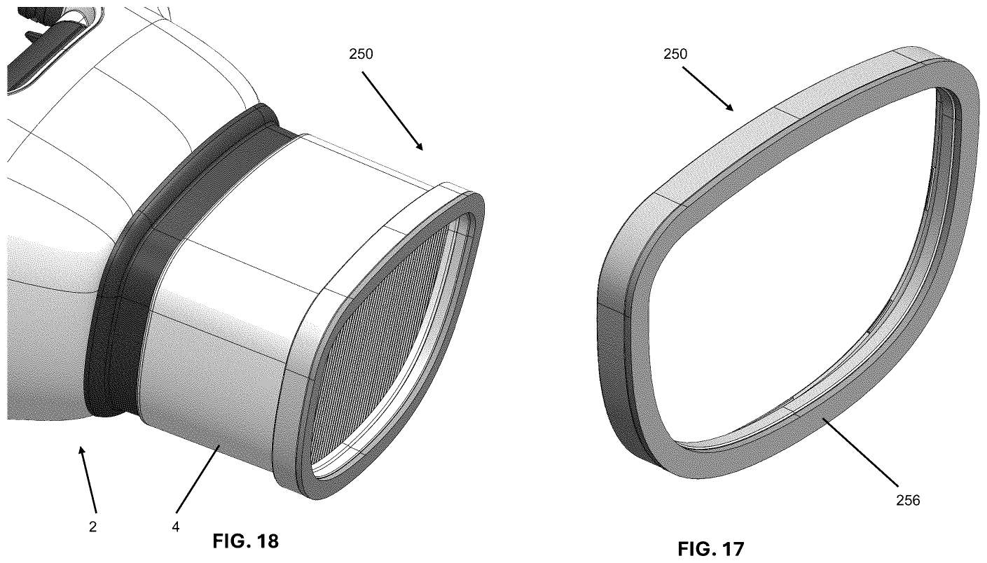

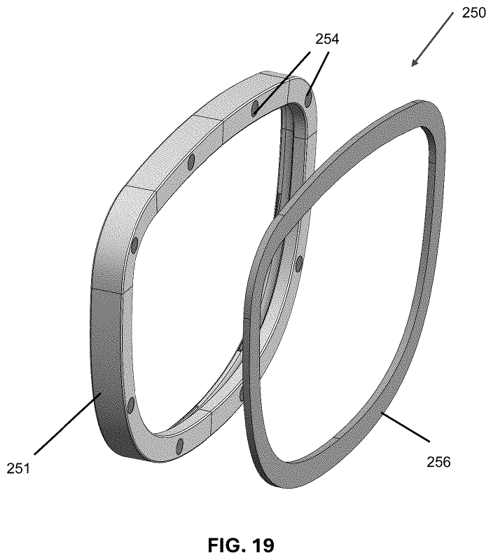

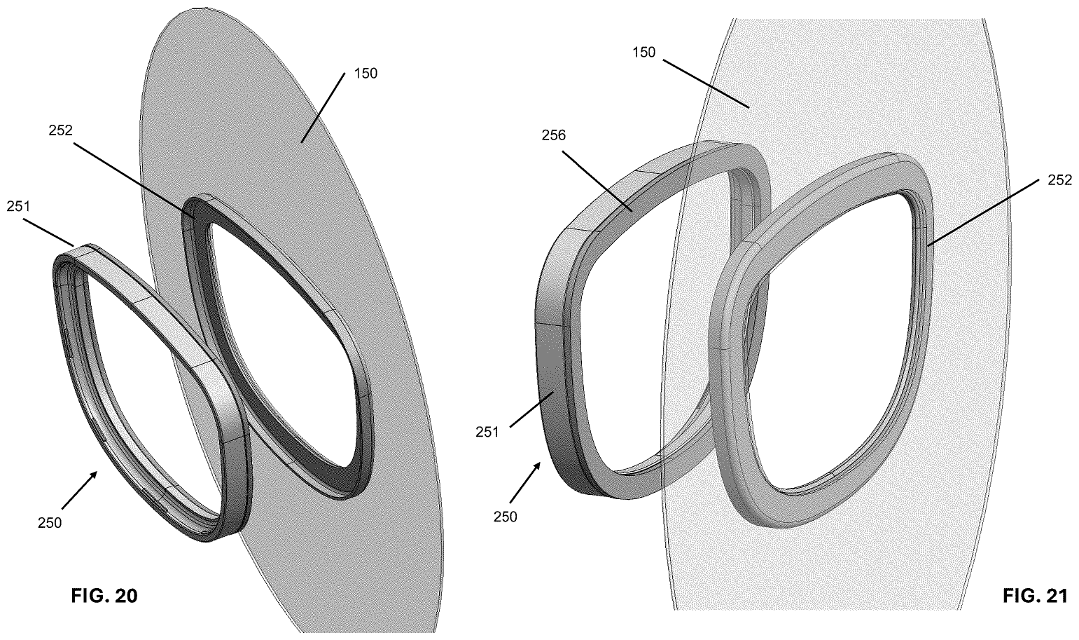

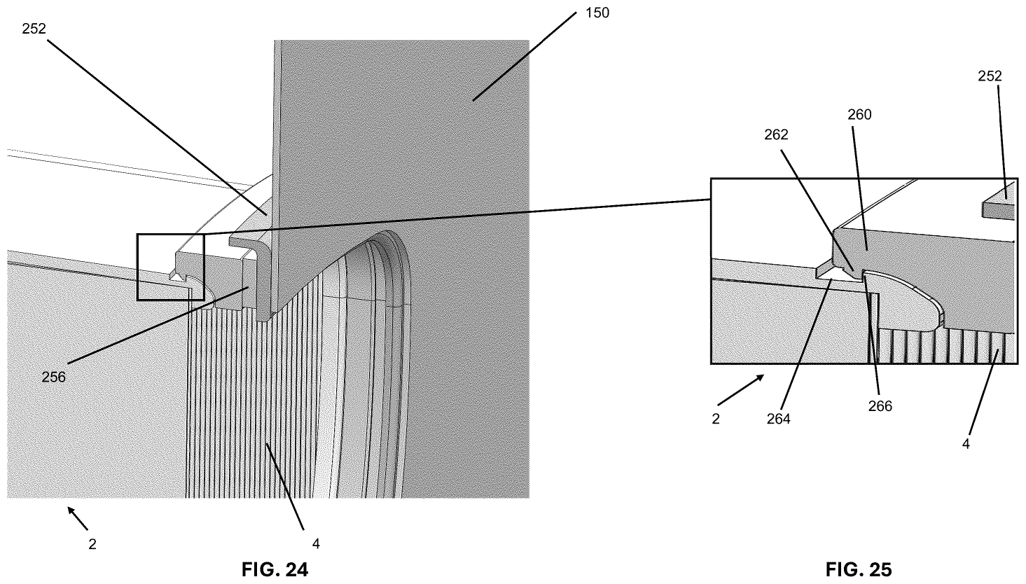

With respect to FIGS. 17-25, there is illustrated still another unique aspect of the present invention. In particular, a snap-on assembly 250 for removably attaching the air intake device 2 having an air filter 4 to the PPE 150 is illustrated. In this embodiment, the assembly 250 is connected to the air intake device 2 at air filter 4, through the use of a latch 262 on extension 260 and edge 266 on groove 264 (FIGS. 24 and 25). It is to be understood that edge 266 on groove 264 is conventionally formed around a periphery around the air filter 4 of air intake device 2. As best shown in FIG. 19, the fasteners 254 such as magnets are located around the periphery of the bezel 251. Also, the PPE 150 is attached to the sealing flange 252 and the gasket seal 256 is attached to the bezel 251 (FIGS. 20 and 21). In this manner, when the PPE 150 is finished being used, the medical personnel can simply remove the PPE 150 from the air intake device 2 at the air filter 4 and properly dispose of the PPE 150.

It is to be understood that the gasket seal 256 can be attached to the snap-on assembly 250 at the plurality of fasteners 254 such as magnets located around a periphery of the bezel 251. It is to be understood that the gasket seal 256 could be constructed of magnetic material as long as the bezel 251 and the flange 252 were also constructed of a metallic material. It is also to be understood that the flange 252 could be constructed of a magnetic material as long as the bezel 251 and the gasket seal 256 were constructed of a metallic material.

Another unique aspect of the present invention is the use of latch 262 and edge 266. As shown in FIGS. 24 and 25, snap-on assembly 250 is located over the removable filter 4 on the e air intake device 2. The snap-on assembly 250 is then pushed or otherwise forced onto the air filter 4 at the groove 264 so that the latch 262 on extension 260 interacts with groove 264. As the snap-on assembly 250 is being further pushed towards air filter 4, the latch 262 proceeds past edge 266 so that latch 262 moves downwardly towards groove 264 which allows latch 262 to contact edge 266. In this manner, latch 262 is retained in place by edge 266 and allows snap-on assembly 250 to remain in place on air filter 4. In order to remove snap-on assembly 250 from air filter 4, the user firmly pulls on snap-on assembly 250 which causes snap-on assembly 250 to become dislodged from air filter 4.

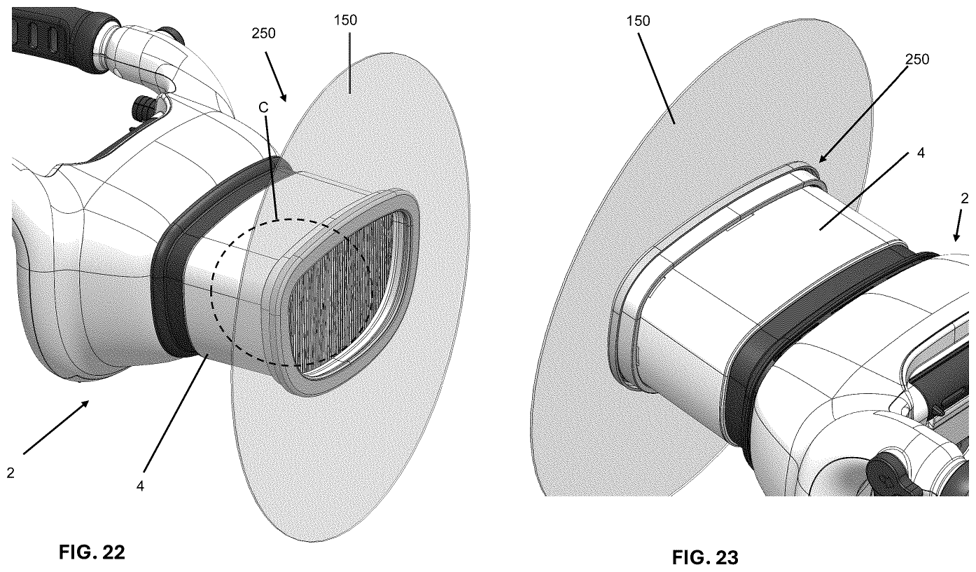

In order to construct snap-on assembly 250, the fasteners 254 are attached around a periphery of the bezel 252. The gasket seal 256 is secured to bezel 251 through the use of the fasteners 254 (FIG. 19). The snap-on assembly 250 is then removably attached to the air filter 4 through the use of the latch 262 on extension 260 and edge 266 on groove 264 (FIGS. 24 and 25). As discussed above, the PPE 150 is equipped with metallic sealing flange 252 (FIGS. 20 and 21), as discussed earlier. Finally, the snap-on fastener 250 is removably attached to the sealing flange 252 so that air intake device 2 is removably attached to the PPE 150 (FIGS. 22 and 23).

A unique aspect of the present invention is the use of the snap-on assembly 250. In particular, the snap-on assembly 250 easily decouples the removable filter 4 from the PPE 150 so that either does not require additional features that increase the cost of the filter 4 or the PPE 150. Also, the fasteners 254 and gasket seal 256 are located on the snap-on assembly 250. This allows the PPE 150 to have a simple stamped metal flange 252 to interface with the fasteners 254 and gasket seal 256. Conversely, the snap-on assembly 250 does not burden the filter 4 with additional complexity and premature replacement due to damage to the gasket seal 256. As well as another potential consumable to sell since the replacement interval of the filter 4 and the gasket seal 256 may be different.

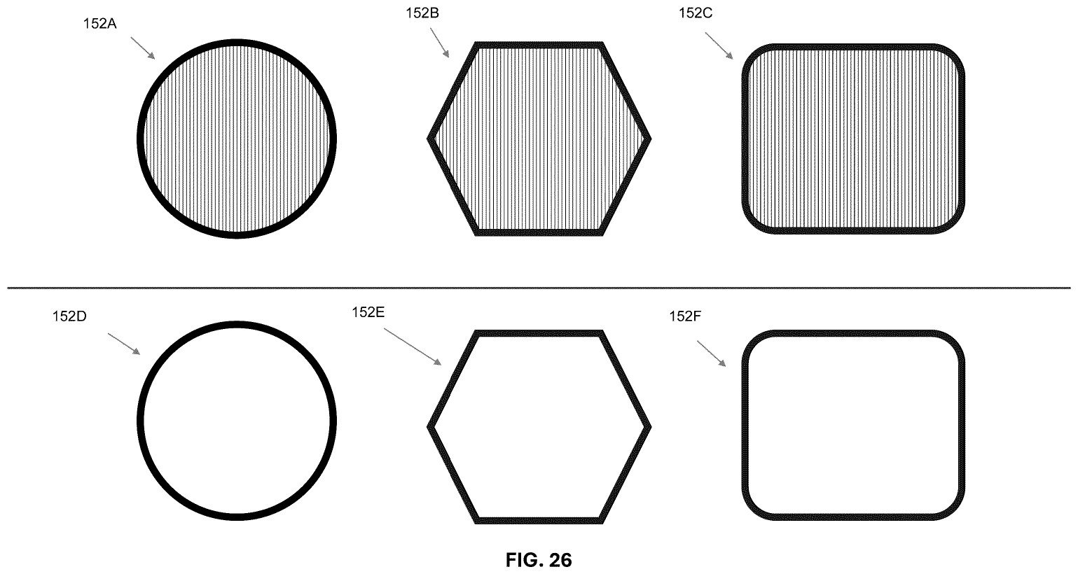

As shown in FIG. 26, there are illustrated several different shape openings (152A to 152F) for the PPE opening 152. In particular, if the sealing flange 202 and the gasket seal 206 are attached to an air intake device 2 that includes a removable filter 4, the shapes of the openings 152A-152C can be used depending upon the shape of the sealing flange 202 and the gasket seal 206. Conversely, if the sealing flange 202 and the gasket seal 206 are attached to an air intake device 2 that does not include a removable filter 4, the shapes of the openings 152D-152F can be used depending upon the shape of the sealing flange 202 and the gasket seal 206.

### Using System for Removably Attaching PPE to an Air Intake Device

With respect to using system 200 for removably attaching personal protective equipment (PPE) 150 to an air intake device 2 (having a removable filter 4 or without a removable filter 4), attention is directed to FIGS. 3-17. With respect to FIG. 3, as discussed above, PPE 150 also includes an opening 152 and seal 154. It is to be understood that PPE 150 is similar to PPE 50 in FIGS. 1 and 2, except that PPE 150 includes a unique opening 152 that is sized and shaped to accommodate the shape of the end of the removable filter 4 or air intake device 2.

With respect to FIGS. 3-9, there is illustrated a first embodiment of the system 200. As shown in FIGS. 4 and 5, system 200 includes, in part, sealing flange 202, fasteners 204 such as magnets or snaps, and gasket seal 206. Preferably, sealing flange 202 and gasket seal 206 are constructed of any suitable, durable, UV resistant, heat resistant, high strength material. Also, sealing flange 202 and the gasket seal 206, preferably, are constructed of a material that is able to interact with fasteners 204 such as magnets or snaps in order to assist in attaching the gasket seal 206 and the sealing flange 202 to the removable filter 4 or the air intake device 2. Also, gasket seal 206, preferably, is constructed so that it creates a compression and friction fit when it is inserted into sealing flange 202 and the fasteners 204 such as magnets or snaps pull on the gasket seal 206 and sealing flange 202. Also, fasteners 204 such as magnets or snaps are located around a periphery of groove 208 that is conventionally formed in the removable filter 4 (FIG. 6). Finally, it is to be understood that snaps or other similar fasteners can be used in place of the fasteners 204 such as magnets or snaps as long as the gasket seal 206 also includes similar snaps or other similar fasteners that are capable of interacting with the fasteners located around the periphery of the groove 208.

In this embodiment, the gasket seal 206 can be attached to the sealing flange 202. The sealing flange 202 having the gasket seal 206 is then attached to the PPE 150. The system 200 can be attached to the air intake device 2 at the removable filter 4 through the use of fasteners 204 such as magnets or snaps. In this manner, when the PPE 150 is finished, being used, the medical personnel can simply remove the PPE 150 from the air intake device 2 at the removable filter 4 and properly dispose of the PPE 150.

With respect to FIGS. 10 and 11, there is illustrated another unique aspect of the present invention. In particular, as shown in FIGS. 10 and 11, the gasket seal 206 can be attached to the removable filter 4. The sealing flange 202 is attached to the PPE 150. The system 200 can be attached to the air intake device 2 at the removable filter 4 through the use of fasteners 204 such as magnets or snaps. In this manner, when the PPE 150 is finished, being used, the medical personnel can simply remove the PPE 150 from the air intake device 2 at the removable filter 4 and properly dispose of the PPE 150.

With respect to FIGS. 12-16, there is illustrated still another unique aspect of the present invention. In particular, the removable filter 4 has been removed from the air intake device 2. In this embodiment, the system 200 is connected to the air intake device 2 through the use of a recess 210 (FIGS. 15 and 16) that is conventionally formed in the air intake device 2. As shown in FIGS. 15 and 16, the fasteners 204 such as magnets or snaps are located around the periphery of the recess 210. Also, the PPE 150 is attached to the sealing flange 202 and the gasket seal 206 is attached to the sealing flange 202. The gasket 206 is removably attached to the fasteners 204 such as magnets or snaps. The system 200 can be attached to the air intake device 2 through the use of fasteners 204 such as magnets or snaps. In this manner, when the PPE 150 is finished, being used, the medical personnel can simply remove the PPE 150 from the air intake device 2 and properly dispose of the PPE 150.

With respect to the use of snap-on assembly 250, attention is directed to FIGS. 17-25. In particular, a snap-on assembly 250 for removably attaching the air intake device 2 having an air filter 4 to the PPE 150 is illustrated. In this embodiment, the assembly 250 is connected to the air intake device 2 at air filter 4, through the use of a latch 262 on extension 260 and edge 266 on groove 264 (FIGS. 24 and 25). It is to be understood that edge 266 on groove 264 is conventionally formed around a periphery of the air filter 4 of air intake device 2. As best shown in FIG. 19, the fasteners 254 such as magnets are located around the periphery of the bezel 251. Also, the PPE 150 is attached to the sealing flange 252 and the gasket seal 256 is attached to the bezel 251 (FIGS. 20 and 21). In this manner, when the PPE 150 is finished being used, the medical personnel can simply remove the PPE 150 from the air intake device 2 at the air filter 4 and properly dispose of the PPE 150.

It is to be understood that the gasket seal 256 can be attached to the snap-on assembly 250 at the plurality of fasteners 254 such as magnets located around a periphery of the bezel 251. It is to be understood that the gasket seal 256 could be constructed of magnetic material as long as the bezel 251 and the flange 252 were also constructed of a metallic material. It is also to be understood that the flange 252 could be constructed of a magnetic material as long as the bezel 251 and the gasket seal 256 are constructed of a metallic material.

Another unique aspect of the present invention is the use of latch 262 and edge 266. As shown in FIGS. 24 and 25, snap-on assembly 250 is located over the removable filter 4 on the air intake device 2. The snap-on assembly 250 is then pushed or otherwise forced onto the air filter 4 at the groove 264 so that the latch 262 on extension 260 interacts with groove 264. As the snap-on assembly 250 is being further pushed towards air filter 4, the latch 262 proceeds past edge 266 so that latch 262 moves downwardly towards groove 264 which allows latch 262 to contact edge 266. In this manner, latch 262 is retained in place by edge 266 and allows snap-on assembly 250 to remain in place on air filter 4. In order to remove snap-on assembly 250 from air filter 4, the user firmly pulls on snap-on assembly 250 which causes snap-on assembly 250 to become dislodged from air filter 4.

In order to construct snap-on assembly 250, the fasteners 254 are attached around a periphery of the bezel 252. The gasket seal 256 is secured to bezel 251 through the use of the fasteners 254 (FIG. 19). The snap-on assembly 250 is then removably attached to the air filter 4 through the use of the use of a latch 262 on extension 260 and edge 266 on groove 264 (FIGS. 24 and 25). As discussed above, the PPE 150 is equipped with metallic sealing flange 252 (FIGS. 20 and 21), as discussed earlier. Finally, the snap-on fastener 250 is removably attached to the sealing flange 252 so that air intake device 2 is removably attached to the PPE 150 (FIGS. 22 and 23).

A unique aspect of the present invention is the use of the snap-on assembly 250. In particular, the snap-on assembly 250 easily decouples the removable filter 4 from the PPE 150 so that either does not require additional features that increase the cost of the filter 4 or the PPE 150. Also, the fasteners 254 and gasket seal 256 are located on the snap-on assembly 250. This allows the PPE 150 to have a simple stamped metal flange 252 to interface with the adapter fasteners 254 and gasket seal 256. Conversely, the snap-on assembly 250 does not burden the filter 4 with additional complexity and premature replacement due to damage to the gasket seal 256. As well as another potential consumable to sell since the replacement interval of the filter 4 and the gasket seal 256 may be different.

As discussed above, as shown in FIG. 26, there are illustrated several different shape openings (152 to 152 F). In particular, if the sealing flange 202 and the gasket seal 206 are attached to an air intake device 2 that includes a removable filter 4, the shapes of the openings 152A-152C can be used depending upon the shape of the sealing flange 202 and the gasket seal 206. Conversely, if the sealing flange 202 and the gasket seal 206 are attached to an air intake device 2 that does not include a removable filter 4, the shapes of the openings 152D-152F can be used depending upon the shape of the sealing flange 202 and the gasket seal 206.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details, or the illustrative examples shown and described. Thus, this disclosure is intended to embrace alterations, modifications, and variations that fall within the scope of the appended claims, which satisfy the statutory subject matter requirements of 35 U.S.C. § 101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

Therefore, provided herein is a new and improved system and method for removably attaching personal protective equipment (PPE) to an air intake device, according to various embodiments of the present invention, wherein the system and method offer the following advantages: ease of use; the ability to quickly and easily attach the PPE to the air intake device; the ability to quickly and easily remove the PPE from the air intake device; the ability to provide an adequate amount of air to the air intake device; reduced weight; and reduced costs to attaching personal protective equipment (PPE) to an air intake device.

In fact, in many of the preferred embodiments, these advantages of: ease of use, the ability to quickly and easily attach the PPE to the air intake device, the ability to quickly and easily remove the PPE from the air intake device, the ability to provide an adequate amount of air to the air intake device, reduced weight, and reduced costs to attaching personal protective equipment (PPE) to an air intake device are optimized to an extent that is considerably higher than heretofore achieved in prior, known systems and methods of attaching personal protective equipment (PPE) to an air intake device.

What is claimed is:

1. A system for removably attaching personal protective equipment (PPE) to an air intake device, comprising:
an air intake device having a removable filter;
a personnel protective equipment (PPE), wherein the PPE includes an opening located on a portion of the PPE such that the opening is sized and shaped to accommodate one end of the removable filter;
a sealing flange operatively connected to the opening;
a gasket seal, wherein the gasket seal is configured to be retained within the sealing flange; and
a plurality of fasteners, wherein the plurality of fasteners is configured to interact with the gasket seal and the sealing flange to removably attach the PPE to the removable air filter.

2. The system, according to claim 1, wherein the gasket seal is attached to the plurality of fasteners.

3. The system, according to claim 1, wherein the gasket seal is attached to the sealing flange.

4. The system, according to claim 1, wherein the removable filter is further comprised of:
a groove located around the periphery of the one end of the removable air filter.

5. The system, according to claim 2, wherein the system is further comprised of;
a snap-on assembly having a bezel, wherein the plurality of fasteners is located around a periphery of the bezel and wherein the gasket seal is configured to be removably attached to the bezel through the use of the plurality of fasteners.

6. The system, according to claim 1, wherein the plurality of fasteners is further comprised of:
a plurality of magnets.

7. The system, according to claim 1, wherein the plurality of fasteners is further comprised of:
a plurality of snaps.

8. A system for removably attaching personal protective equipment (PPE) to an air intake device, comprising:
an air intake device;
a personnel protective equipment (PPE), wherein the PPE includes an opening located on a portion of the PPE such that the opening is sized and shaped to accommodate one end of the air intake device;
a sealing flange operatively connected to the opening;
a gasket seal, wherein the gasket seal is configured to be retained within the sealing flange; and
a plurality of fasteners located around a periphery of the one end of the air intake device, wherein the plurality of fasteners is configured to interact with the gasket seal and the sealing flange to removably attach the PPE to the air intake device.

9. The system, according to claim 8, wherein the gasket seal is attached to the plurality of fasteners.

10. The system, according to claim 8, wherein the gasket seal is attached to the sealing flange.

11. The system, according to claim 8, wherein the removable filter is further comprised of:
a recess located around the periphery of the one end of the air intake device, wherein the recess is configured to retain the plurality of magnets.

12. The system, according to claim 8, wherein a shape of the opening can be adjusted depending upon a shape of the sealing flange and a shape of the gasket seal.

13. The system, according to claim 8, wherein the plurality of fasteners is further comprised of:
a plurality of magnets.

14. The system, according to claim 8, wherein the plurality of fasteners is further comprised of:
a plurality of snaps.

15. A method removably attaching personal protective equipment (PPE) to an air intake device, comprising:
providing an air intake device having a removable filter;
providing a personnel protective equipment (PPE), wherein the PPE includes an opening located on a portion of the PPE such that the opening is sized and shaped to accommodate one end of the removable filter;
attaching a sealing flange to the opening;
providing a gasket seal, wherein the gasket seal is configured to be retained within the sealing flange;
providing a plurality of fasteners; and
using the plurality of fasteners to interact with the gasket seal and sealing flange to removably attach the PPE to the removable air filter.

16. The method, according to claim 15, wherein the gasket seal is attached to the plurality of fasteners.

17. The method, according to claim 15, wherein the gasket seal is attached to the sealing flange.

18. The method, according to claim 15, wherein the removable filter is further comprised of:
providing a groove around the periphery of the one end of the removable air filter.

19. The method, according to claim 16, wherein the method is further comprised of:
providing a snap-on assembly having a bezel, wherein the plurality of fasteners is located around a periphery of the bezel and wherein the gasket seal is configured to be removably attached to the bezel through the use of the plurality of fasteners.

20. The method, according to claim 15, wherein the plurality of fasteners is further comprised of:
a plurality of magnets.
